(19) United States
(12) Patent Application Publication
(10) Pub. No.: US 2014/0060383 A1
(43) Pub. Date: Mar. 6, 2014

(54) THERMOPLASTICS FROM POULTRY FEATHERS

(71) Applicant: The Governors of the University of Alberta, Edmonton (CA)

(72) Inventors: Jianping WU, Edmonton (CA); Aman ULLAH, Edmonton (CA); David BRESSLER, Edmonton (CA)

(73) Assignee: THE GOVERNORS OF THE UNIVERSITY OF ALBERTA, Edmonton (CA)

(21) Appl. No.: 14/011,303

(22) Filed: Aug. 27, 2013

Related U.S. Application Data
(60) Provisional application No. 61/694,475, filed on Aug. 29, 2012.

(51) Int. Cl. C08L 89/04; B29C 43/00

(52) U.S. Cl. CPC C08L 89/04; B29C 43/003
USPC 106/156.22; 106/156.51; 106/156.5; 264/330

(57) ABSTRACT

The invention is directed to thermoplastics derived from feathers. The thermoplastics are prepared by blending whole feathers or portions thereof with a plasticizer in an amount ranging from about 20 wt to about 40 wt % and a reducing agent in an amount ranging from about 1 wt % to about 5 wt % to form a mixture; and either extruding the mixture to form an article, or pressing the mixture into a film at an elevated temperature.

### CROSS-REFERENCE TO RELATED APPLICATIONS

This application claims the priority benefit of U.S. Provisional Patent Application No. 61/694,475 filed on Aug. 29, 2012 entitled “Thermoplastics from Poultry Feathers”, the contents of which are incorporated herein by reference (where permitted).

### FIELD OF THE INVENTION

The present invention relates to thermoplastics derived from feathers.

### BACKGROUND OF THE INVENTION

Biopolymers from renewable resources are emerging alternatives to petroleum derived plastics (petro-plastics) due to their biodegradability and environmental friendliness (Vroman et al., 2009). Recently, focus has shifted to proteins which are robust and easily available as waste or by-product of the horticultural and agricultural industries. Proteins have been processed into plastics using solvent castings and compression molding techniques (Schrooyen et al., 2000; Mangavel et al., 2003; Wei et al., 1999; Anderson et al., 2000). However, there are few reports on extrusion processing of proteins for non-food applications (Redl et al., 1999; Sessa et al., 2006; Brauer et al., 2007). To compete with petroleum-based materials, plastics from different biodegradable and renewable sources must be processable by using existing industrial processing techniques.

Feathers are composed of keratin which is also found in nails, hairs, epidermis, horn, and hoof (Vincent, 1990). Feather keratin has a molecular weight of about 10,500 g/mol and contains about 7% cysteine which forms sulfur-sulfur bonds with other cysteine molecules (Fraser et al., 1972; Arai et al., 1983). These cysteine linkages (cysteine-cysteine cross-links or disulfide bridges) make keratin stiff and require the reduction of keratin to break the cross-links (Barone et al., 2006). Feathers are typically composed of 50% fiber and 50% quill by weight (Reddy et al., 2007).

Attempts have been made to modify poultry feather fibers by either surface grafting of synthetic polymers or blending with a plasticizer to transform the fibers into films using casting, compression molding, or extrusion techniques. Chicken feather fibers have been modified through graft copolymerisation with methyl methacrylate using a KMnO₄/malic acid redox system (Martinez-Hernandez et al., 2003). Graft polymerization with methyl acrylate using a K₂S₂O₈/NaHSO₃ redox system and preparation of films by compression molding grafted feathers using glycerol have been reported (Jin et al., 2011). Films have also been prepared by casting blends of reduced keratin with glycerol (Schrooyen et al., 2001). U.S. Pat. No. 7,066,995 to Barone et al, describes the preparation of avian feather keratin based films by compression molding without reducing or oxidizing agents, and using at least one OH containing plasticizer, particularly glycerol. Glycerol effectively plasticizes various proteins due to its ability to interact with polar amino acid residues. However, any plasticizer which works for one protein may be unsuitable for another protein due to differences in amino acid sequences (Di Gioia et al., 1999).

Therefore, there is a need in the art for methods of converting animal byproducts such as feathers into useful products.

### SUMMARY OF THE INVENTION

The present invention relates to thermoplastics derived from feathers.

In one aspect, the present invention provides a method of producing a thermoplastic from feathers, comprising the steps of:
a) blending whole feathers or portions thereof with a plasticizer in an amount ranging from about 20 wt % to about 40 wt % and a reducing agent in an amount ranging from about 1 wt % to about 5 wt % to form a mixture; and
b) either extruding the mixture to form an article, or pressing the mixture into a film at an elevated temperature.

In one embodiment, the plasticizer comprises a polar or an amphiphilic plasticizer. In one embodiment, the plasticizer comprises propylene glycol, glycerol, ethylene glycol, or diethyl tartrate.

In one embodiment, the portion comprises quill or feather fiber, and the plasticizer comprises ethylene glycol or diethyl tartrate. In one embodiment, whole feathers are blended with the plasticizer comprising propylene glycol or glycerol. In one embodiment, the plasticizer is in an amount of about 30 wt % and the reducing agent is in an amount of about 3 wt %.

In one embodiment, the reducing agent comprises sodium sulfite, potassium cyanide, or thioglycolic acid. In one embodiment, the reducing agent comprises sodium sulfite.

In one embodiment, extrusion is conducted at a temperature in the range of about 90° C. to about 140° C., using, for example, a twin-screw extruder is used.

In one embodiment, pressing comprises compression molding. In one embodiment, compression molding is conducted at a pressure of about 3,500 psi for about five minutes. In one embodiment, compression molding is conducted at a temperature of about 110° C.

In one aspect, the invention comprises a thermoplastic comprising feather keratin, a plasticizer, and a reducing agent, and articles comprising the thermoplastic.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 shows FTIR spectra of quill-keratin based resins (X), fiber-keratin based resins (Y), and feather-keratin based resins (Z), while (A) represents corresponding keratin; (B) ethylene glycol (EG) plasticized; (C) propylene glycol (PG) plasticized; (D) glycerol (G) plasticized; and (E) diethyl tartrate (DET) plasticized extrudates.

FIG. 2 shows the representative stress-strain curves of extrudates of quill-keratin (A), fiber-keratin (B), and feather-keratin (C) plasticized with different plasticizers.

FIG. 3 shows DSC heat flow signals (Endo) of quill (A), fiber (B) and whole feather (C) extrudates plasticized with EG, PG, G, and DET.

FIG. 4 shows a DMA plot of storage modulus (E′) and tan delta for quill-keratin (A), fiber-keratin (B), and feather-keratin (C) based extruded materials.

FIG. 5 shows TGA curves of quill material and plasticized resins (A), fiber and its plasticized resins (B), and whole feather and its plasticized resins (C). The DTG curves have been offset for clarity.

FIG. 6 shows photographs of films prepared from extruded quill (A), fiber (B), and whole feather (C) keratins plasticized by using same weight fractions of different plasticizers.

### DETAILED DESCRIPTION OF PREFERRED EMBODIMENTS

The present invention relates to thermoplastic materials derived from feathers. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

Embodiments of the present invention utilize avian feathers which are modified to form a thermoplastic material having desirable physical and chemical properties. The thermoplastics formed by these methods may be used for various applications.

In one embodiment, the invention comprises a method for preparing a thermoplastic from feathers, comprising the steps of:
a) blending whole feathers or portions thereof with a plasticizer in an amount ranging from about 20 wt % to about 40 wt % and a reducing agent in an amount ranging from about 1 wt % to about 5 wt % to form a mixture; and
b) either extruding the mixture to form an article, or pressing the mixture into a film at an elevated temperature.

The thermoplastics are produced from avian feathers using the methods described herein. The method generally involves at least the step of blending whole feathers or portions thereof with a plasticizer in an amount ranging from about 20 wt % to about 40 wt % and a reducing agent in an amount ranging from about 1 wt % to about 5 wt % to form a mixture. The physical properties of the resultant thermoplastics may be suitable for use in many different applications. A “thermoplastic” material is a polymer which becomes pliable or moldable above a certain temperature, and returns to a solid state upon cooling.

As used herein, the term “feather” refers to an integumentary appendage of an avian species. As used herein, the term “avian species” includes, but is not limited to, chickens, turkeys, quails, ducks, geese, pigeons, doves, pheasants, emu, swans, and ostriches. In one embodiment, the avian species comprises a chicken or turkey. A typical avian feather has a central shaft or rachis to which two vanes are attached on either side. The vanes are formed of barbs, barbules (i.e., extensions from the barbs), and barbicels (i.e., hooks which interlock to hold barbules together). As used herein, the term “fiber” refers to the vanes. At the base of the feather, the rachis expands to form the quill or calamus, a hollow shaft which inserts into a skin follicle. The term “feather” includes, but is not limited to, primary feathers, secondary feathers, tail feathers, contour feathers, down feathers, filoplumes, semiplume feathers, and bristle feathers. Feathers contain about 90% keratin protein. Feather keratin is composed of ordered α-helix or β-sheet structures and some other disordered structures. Feather fiber has a higher percentage of α-helix compared to β-sheet, while the quill is composed of more β-sheet than α-helix structure.

In one embodiment, freshly plucked feathers are cleaned and dried. The whole feather or a portion thereof may be used. In one embodiment, the portion comprises the quill or feather fiber. The whole feather, quill or fiber is ground into a powder and further cleaned using a suitable degreasing solvent, such as petroleum ether, to remove grease. The solvent may then be removed, such as by evaporation, to yield a powdered feather fraction.

The powdered feather fraction is mixed with a plasticizer in a suitable amount, which may range from about 20 wt % to about 40 wt %. In one embodiment, the plasticizer is added in an amount of about 30 wt %. A plasticizer is a substance which disperses within the feather keratin and increases the plasticity or fluidity of the resulting thermoplastic resin. Plasticizers act by reducing hydrogen bonding, van der Waals, or ionic interactions that hold polymer chains together, by forming plasticizer-polymer interactions (Leblanc et al., 2008), by adding free volume to the system, by causing a physical separation of adjacent chains, and/or by acting as lubricants between chains.

In one embodiment, the plasticizer comprises a polar or an amphiphilic plasticizer. As used herein, the term “polar plasticizer” means a plasticizer which readily absorbs or dissolves in water. As used herein, the term “amphiphilic plasticizer” means a plasticizer having a polar, water-soluble group attached to a nonpolar, water-insoluble hydrocarbon chain. Suitable plasticizers include, but are not limited to, glycerol, propylene glycol, ethylene glycol, polyethylene glycol, phthalate, phthalic derivatives, diethylphthalate, dibutylphthalate, butylphthalylbutylglycolate, triacetine, silicone oil, triethyl citrate, dibutyl sebacate, octanoic acid, palmitic acid, diethyl tartrate, and dibutyl tartrate.

In one embodiment, the plasticizer comprises propylene glycol, glycerol, ethylene glycol, or diethyl tartrate. In one embodiment, the feather portion comprises quill or feather fiber, and the plasticizer comprises ethylene glycol or diethyl tartrate. In one embodiment, whole feathers are blended with the plasticizer comprising propylene glycol or glycerol.

Feather keratin contains about 7% cysteine, which forms sulfur-sulfur bonds with other cysteine residues. In one embodiment, a reducing agent is added to the mixture of the feather fraction and plasticizer to dissociate the disulfide bonds and to achieve efficient mixing of the keratin and plasticizer. In one embodiment, the reducing agent is added in an amount ranging from about 1 wt % to about 5 wt %. In one embodiment, the reducing agent is added in an amount of about 3 wt %. In one embodiment, the reducing agent comprises sodium sulfite, potassium cyanide, or thioglycolic acid. In one embodiment, the reducing agent comprises sodium sulfite.

In one embodiment, the thermoplastic comprises about 70 wt % of feather fraction, about 30 wt % of plasticizer, and about 3 wt % of reducing agent.

In one embodiment, the feather fraction, plasticizer, and reducing agent are blended at a speed of about 2200 rpm for about twenty minutes. The blend is left for sufficient time for the plasticizer to be incorporated into the feather fraction to yield a thermoplastic resin. In one embodiment, the blend may be kept at room temperature overnight.

In one embodiment, the invention comprises thermoplastics obtained by the methods described herein. The physicochemical properties of the resultant thermoplastics may be evaluated to assess their suitability for particular applications. Such properties may include, but are not limited to, conformational changes and plasticizer-protein interactions, protein denaturation and thermal degradation, viscoelastic properties, and mechanical properties including tensile strength, breaking elongation and Young's modulus.

The thermoplastics produced by the above process are useful in forming operations such as, for example, extrusion, film preparation, or other processes well known in the art. In one embodiment, the thermoplastic resin is subjected to an extrusion process. In the extrusion process, the thermoplastic resin is forced through a die of a desired cross-section to produce an article which maintains a relatively consistent size and shape. Various types of commercially available extruders may be used. Either a single-screw extruder or a twin-screw extruder can be used. In one embodiment, a twin-screw extruder is preferably used. In one embodiment, extrusion may be conducted at an elevated temperature in the range of about 90° C. to about 140° C. After extrusion, the extruded product is cooled to room temperature.

In one embodiment, the thermoplastic is thermo-pressed into a film at an elevated temperature. As used herein, the term “film” means a thermoplastic in the form of a sheet having a thickness in the range of about 0.1 mm to about 1.0 mm, and preferably about 0.2 mm to about 0.5 mm. In one embodiment, the temperature ranges between about 100° C. to about 140° C. In one embodiment, the temperature is about 110° C. In one embodiment, thermo-pressing comprises compression molding. Briefly, the thermoplastic is placed in an open, heated mold cavity. The mold is closed with a top force or plug member, pressure is applied to force the thermoplastic into contact with all mold areas, and heat and pressure are maintained until the thermoplastic has cured. In one embodiment, compression molding is conducted a pressure of about 3,500 psi for about five minutes. The films are then cooled before the removal from the mold.

In one embodiment, the invention comprises an article comprising a thermoplastic obtained by the above method. Non-limiting examples of articles include shrink film, cling film, stretch film, sealing films, food packaging, bags, medical packaging, industrial liners, bottles, pots, food containers, and the like in food-contact and non-food contact applications.

Exemplary embodiments of the present invention are described in the following Examples, which are set forth to aid in the understanding of the invention, and should not be construed to limit in any way the scope of the invention as defined in the claims which follow thereafter. As will be apparent to those skilled in the art, various modifications, adaptations and variations of the specific disclosure herein can be made without departing from the scope of the invention claimed herein.

### EXAMPLE 1

### Sample Preparation

Freshly plucked, white chicken feathers (Poultry Research Centre, University of Alberta) were washed several times with soap (Palmolive™, antibacterial) and adequate hot water. The cleaned feathers were dried by first placing under a closed fume hood for four days to evaporate water and then in a ventilated oven at 50° C. for 8 h to completely remove remaining moisture. The cleaned and dried feathers were processed with scissors, and the quill portion was separated from the fiber portion. Quill, fiber and whole feather were ground using a Fritsch cutting mill at a sieve insert size of 0.25 mm (Pulverisette 15, Laval Lab. Inc., Laval, Canada). The batches of ground feather materials (30 g each) were then treated in a Soxhlet (extraction tube with 50 mm internal diameter) for 4 h with 250 mL of petroleum ether to remove grease. The petroleum ether was evaporated and the dried feather material was stored at room temperature in an airtight containers.

Blends of ground feather fractions with different plasticizers including ethylene glycol (EG), propylene glycol (PG), glycerol (G), and diethyl tartrate (DET), and sodium sulfite were prepared in a laboratory heavy duty blender (Waring Commercial, 120 volt, Torrington, Conn.). In a typical blend, 70 grams of feather material (quill, fiber or whole feather), 30 grams of plasticizer, and 3 grams of sodium sulfite were mixed in a blender at high speed (2200 rpm) for twenty minutes, with one minute break (for removing the material stuck to the blender walls) after every three minutes blending. The resulting resins were sealed in plastic bags and placed at room temperature overnight.

### EXAMPLE 2

### Extrusion

Extrusion was performed using a twin-screw extruder (Plasti-corder Digi-system, PL 2200, Brabender Instruments, Inc South Hackensack, N.J.). The screws were single flighted and had uniform pitch. The barrel length was 35 cm with a diameter of 31.8/20 mm. A 7 mm die was used. Extrusion was conducted at 90, 100, 110, 120 and 140° C., with a screw speed of 50 rpm. After extrusion, samples were cut and cooled to room temperature.

### EXAMPLE 3

### Film Preparation

Films for mechanical testing of plasticized materials were prepared by compression molding the resins for 5 minutes at 110° C. and 3500 psi pressure using a Carver press (Model 3851-0, Carver Inc., Wabash, Ind., USA).

### EXAMPLE 4

### FT-IR Characterization

Fourier transformed infrared spectra of quill and plasticized resins were obtained on a FTIR (Bruker Vertex 70, Billerica, Mass., USA) with an attached Hyperion 2000 FTIR Microscope spectrometer fitted with a germanium attenuated total reflection (ATR) microscope objective. A mercury cadmium telluride (MCT) detector was used. Thin slices of the extrudates were cut and equilibrated at 0% relative humidity in a desiccator containing P₂O₅ for two weeks prior to FTIR investigation. The spectra were collected within the frequency range 4000-650 cm⁻¹, under the same conditions as the background. All sample spectra were recorded at 128 scans and 4 cm⁻¹ resolution, and spectra of two replicate measurements for each sample were averaged. The infrared spectra were acquired using Bruker OPUS software (version 5.5) and analyzed by using Thermo Scientific OMNIC software package (version 7.1). Fourier transformed infrared spectra of fiber and whole feather and their plastics in KBr pellets were obtained on a FTIR spectrophotometer (Thermo Nicolet 750, Madison, Wis., USA). Small pieces of extrudates were cut and equilibrated at 0% relative humidity in a desiccator containing P₂O₅ for two weeks prior to FTIR investigation. The spectra were collected within the frequency range 4000-400 cm⁻¹. All sample spectra were recorded at 32 scans and 4 cm⁻¹ resolution, and spectra of two replicate measurements for each sample were averaged. The infrared spectra were acquired using Thermo Scientific OMNIC software package (version 7.1).

The effects of different plasticizers on the thermoplastic properties were assessed. The conformational changes and plasticizer-protein interactions in the extruded resins were assessed by FTIR. Protein unfolding and aggregation directly determine molecular interactions, network density and other properties. FTIR may be used to determine the secondary structure of a protein. Through proper fitting of the amide I band of the original FTIR spectrum of a protein, the conformation of the protein (e.g., helix, sheet or turn) can be obtained. Particularly, the amide I band in the range between 1600 cm⁻¹ and 1700 cm⁻¹ and amide II band in the region of 1510 cm⁻¹ and 1580 cm⁻¹ provide useful information. Amide I, which is the most intense absorption band in proteins, is useful for the analysis of the protein secondary structure and arises mainly from C═O stretching, with a minor contribution from C—N stretching, while the amide II band originates from the N—H bending and C—H stretching vibrations (Jackson et al., 1995).

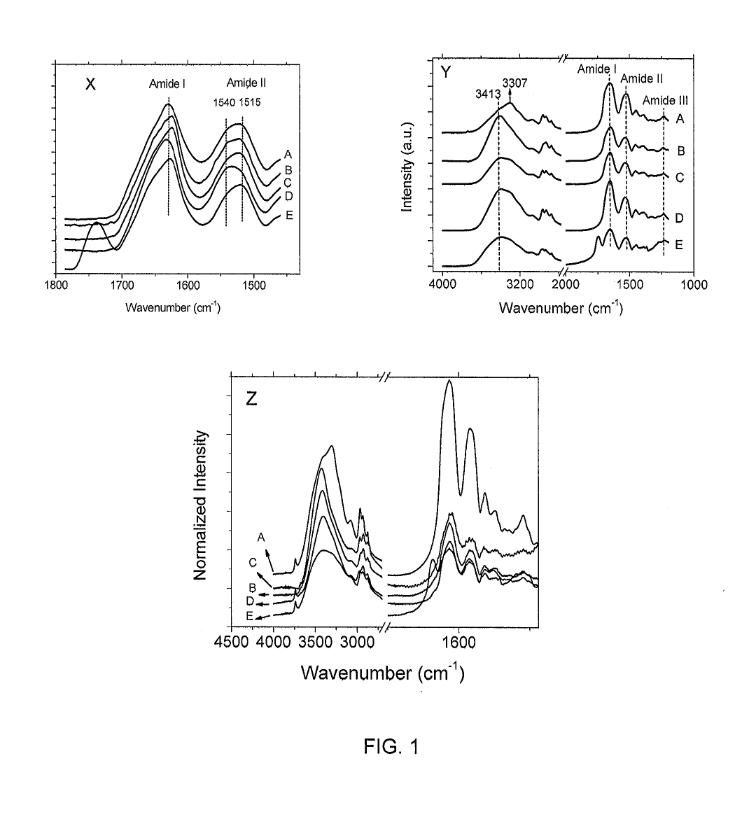

FIG. 1 shows the IR spectra of quill and plasticized resins (X). Significant changes can be seen in amide I and amide II regions of resins formed with different plasticizers. As evident from amide I peak at 1630 cm⁻¹ (A), the quill consists mainly of β-sheet structure. A shift in the wavenumber of 1630 cm⁻was observed as a function of plasticizer type. In the presence of ethylene glycol, propylene glycol, and diethyl tartrate (B, C and E), this peak shifted to lower wavenumbers located at 1623 cm⁻¹, 1624 cm⁻¹ and 1627 cm⁻¹ respectively. The shifts in amide I bands towards a lower frequency were indicative of increased amounts of ordered β-sheet structures.

In the presence of glycerol, a shift towards higher wavenumber values was observed, indicating decreased β-sheet interactions with glycerol and the promotion of disordered structures. The amide II band is related with N—H bending and C—H stretching vibrations. Although it is much less conformationally sensitive than amide I, it is much more sensitive to the environment of the N—H group (Jung, 2000). The amide II band can be used to deduce changes to the environment of the N—H groups and respond to differences in hydrogen bonding environments (Almutawah et al., 2007). Stronger hydrogen bonded N—H groups absorb at higher frequencies. As compared to the neat quill, a decrease in absorption intensity centered at 1515 cm⁻¹ is observed in the presence of ethylene glycol, propylene glycol, and glycerol. However, the relative intensity at 1540 cm⁻¹ increases, with this increase being more prominent in the presence of ethylene glycol and glycerol. A distinct peak at 1738 cm⁻¹ in diethyl tartrate plasticized resin is due to C═O stretching absorption of two carbonyl groups present in diethyl tartrate, a characteristic absorption range (1750-1735 cm¹) for aliphatic esters (Smith, 1999).

The IR spectra of feather fiber and plasticized resins (Y) exhibit typical amide vibrations including amide A (N—H stretching, 3200-3500 cm⁻¹), amide I (C═O stretching, with a minor contribution from N—H bending and C—N stretching, 1600-1700 cm¹), amide II and amide III (N—H bending and C—N stretching, at around 1540 and 1240 cm⁻¹, respectively). Significant changes can be seen in amide A region of resins formed with different plasticizers. A broad absorption band of neat fiber-keratin appearing at 3307 cm⁻¹ (A) is mainly due to hydrogen bonded N—H stretching vibrations, as in native secondary structure the peptide N—H groups make hydrogen bonds with amide C═O groups (Trabocchi et al., 2002). A shift in this band towards higher wavenumbers as a function of plasticizer type has been observed, which becomes sharp particularly in the presence of glycerol and ethylene glycol (B and D).

Without being bound by any theory, this shift to higher wavenumbers may be attributed to the disruption of the internal hydrogen bonds of the peptide groups by plasticizers and formation of new bonds between protein and plasticizers. Polyols disrupt internal hydrogen bonds of proteins by the competition between the O—H groups of alcohol and N—H groups of peptide for making hydrogen bonds with the amide C═O groups (Gilbert et al., 2005). It is also well known that the absorption peak due to free O—H in alcohols appears at around 3600 cm⁻¹, while hydrogen bonded O—H groups absorb at lower wavenumbers (Bellamy, 1975). The positions of these bands reflect the strength of hydrogen bonding, while another general characteristic of these hydrogen bonds is that the stronger the hydrogen bond, the greater the intensity of the corresponding peak (Schmidt et al., 2006).

Resin prepared from whole feather (Z) demonstrated that propylene glycol (C) was able to interact more effectively, followed by ethylene glycol (B) and glycerol (D). Diethyl tartrate (E) showed less H-bonding interactions with mixture keratin.

### EXAMPLE 5

### Mechanical Property Measurements

Stress-strain curves from tensile tests are commonly used to characterize polymer properties including, but not limited to, elastic modulus, tensile strength and percent elongation at break (Billmeyer, 1984).

Mechanical properties (tensile strength, breaking elongation, and Young's modulus) of the films were determined at room temperature on an Instron (5967, Norwood, Mass., USA) equipped with a 50 N load cell at a crosshead speed of 50 mm/min. The data for each sample were obtained from an average of testing at least four specimens with an effective length of 80 mm and width of 10 mm.

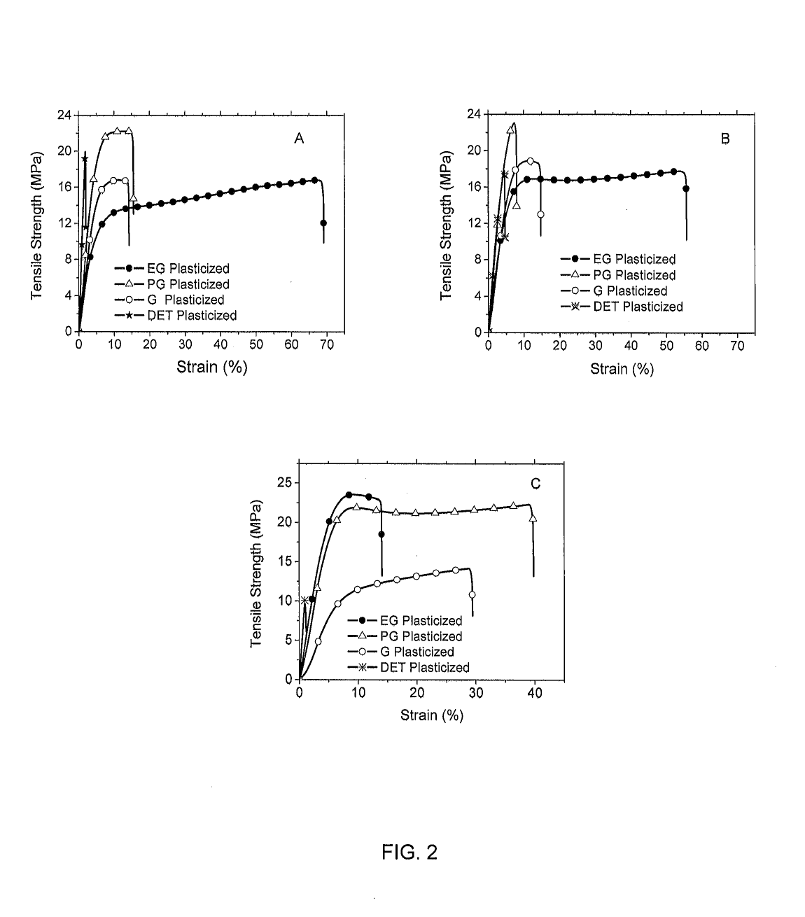

The pressed films of quill, feather fiber and whole feather (without plasticizers) were too brittle to perform mechanical testing, while the mechanical properties of the quill, fiber, and feather extrudates with different plasticizers are shown in FIGS. 2A-C. In both fiber and quill plasticized resins, propylene glycol and diethyl tartrate plasticized materials showed higher tensile modulus, moderate tensile strength, but lower breaking elongation than both ethylene glycol and glycerol plasticized resins. Although ethylene glycol plasticized extrudates had only a slightly higher tensile strength compared to glycerol plasticized material, the elongation at the break point of ethylene glycol plasticized plastics was significantly greater than for glycerol plasticized resins. A common consensus is that a true plasticizer generally increases the flexibility and extensibility of the plasticized material while its interactions at a molecular level increase tensile strength and stiffness (Verbeek et al., 2010). Ethylene glycol was able to plasticize more effectively to both quill and fiber materials. On the contrary, propylene glycol was better plasticizer for feather plastics (FIG. 2C).

### EXAMPLE 6

### Differential Scanning Calorimetry (DSC) Characterization

DSC was performed under a continuous nitrogen purge on a calorimetric apparatus (Pyris 1, Perkin Elmer, Norwalk, Conn., USA). The instrument heat flow and temperature were calibrated using a sample of pure indium. Samples of about 5 mg were scanned at 10° C./min from 25 to 275° C.

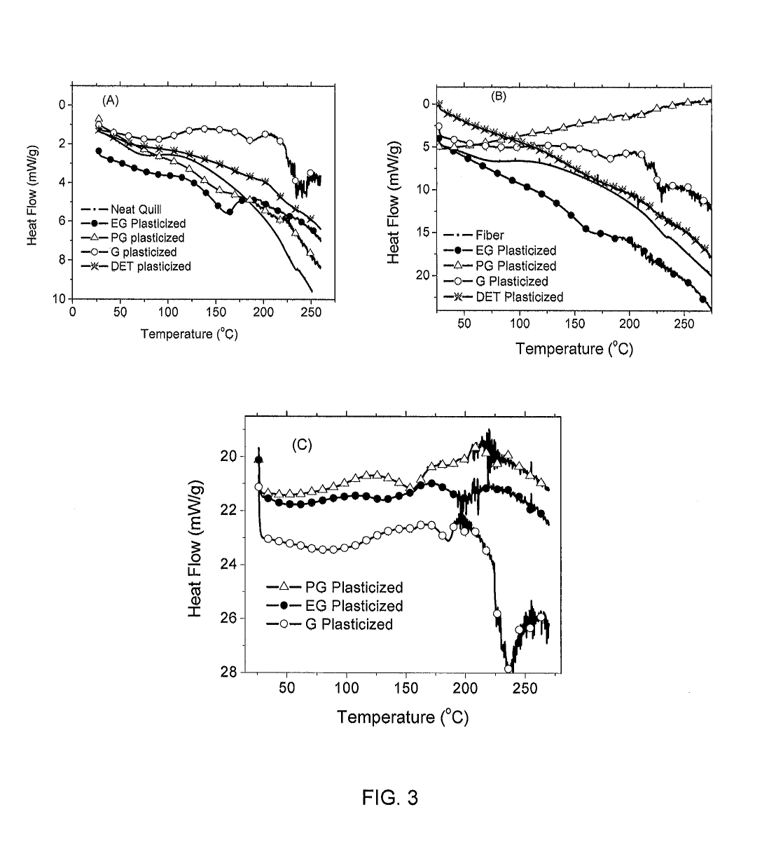

The thermal transitions of the quill, fiber and whole feather as well as extrudates plasticized by different plasticizers were studied by DSC. Typical heat flow curves of quill, fiber and their corresponding extruded plastics are shown in FIGS. 3A-B. Both quill and fiber keratin materials exhibited two transitions: a low temperature broad peak at about 80-100° C. likely due to evaporation of residual moisture of the protein and a small peak at around 233° C. that might be due either to crystalline melting. For the extrudates, the moisture evaporation peak shifted to higher temperatures. A decrease in the magnitude of this peak for propylene glycol and diethyl tartrate was observed in fiber and quill plasticized resins. All plasticized resins showed a second endothermic peak (attributed to crystalline melting) at a lower temperature compared to neat keratin materials. A sharp endothermic peak was clearly observed at lower temperature for the ethylene glycol plasticized resin both in quill and fiber extrudates than other plasticizers, which demonstrates higher improvement in thermoplasticity compared to other plasticizers. The two peaks observed for the glycerol plasticized quill and fiber material may be due to two types of interaction of glycerol with quill and fiber keratin: a glycerol-rich zone where glycerol is loosely bound to proteins, and a protein-rich zone where glycerol has greater interactions with proteins. For whole feather extrudates (FIG. 3C), it was observed that propylene glycol gave relatively sharp second transition at lower temperature compared to other plasticizers, suggesting that propylene glycol more effectively plasticized feather material and significantly improved thermoplasticity.

### EXAMPLE 7

### Dynamic Mechanical Analysis (DMA)

A dynamic mechanical analyzer (DMA 8000, Perkin Elmer, Waltham, Mass., USA) was used to measure dynamic mechanical properties in tensile mode at an oscillatory frequency of 1 Hz with an applied deformation of 0.05 mm during heating. Analyses were performed on rectangular specimens having dimensions of approximately 11×6×0.8 mm (length×width×thickness). The thicknesses and widths of the samples were measured with digital calipers at three different places and averaged. Each sample was analyzed at least in duplicate. Temperature scans between 0 and 160° C. were performed at 2° C./min heating rate. Specimens were equilibrated (two weeks) at 0% relative humidity in a desiccator containing P₂O₅ prior to analysis. For quill material, analysis was performed using a temperature ramp from 0 to 240° C. at a heating rate of 2° C./min. The storage modulus (E′) and tan δ(E″/E′) were recorded as a function of temperature.

DMA is used to measure the changes in the viscoelastic properties of the polymers with changing temperature. Thermal transitions are generally associated with chain mobility, with the most important of these transitions being the glass transition (T_{g}) which is related to the onset of major chain motion (Bengoechea et al., 2007).

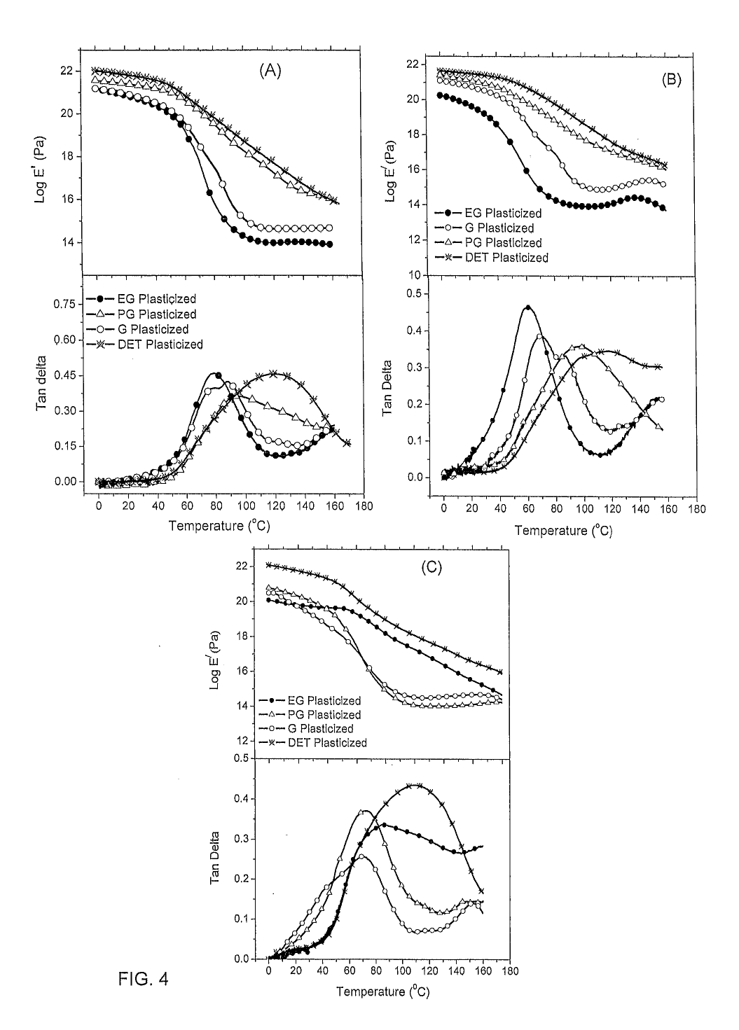

FIG. 4 shows changes in storage modulus and tan delta values of quill material (A), fiber material (B), and whole feather (C) plasticized with different plasticizers as a function of temperature. The T_{g} values have been determined from tan δ versus temperature plots. A clear shift in the onset of E′ drop to a lower temperature can be seen in the plasticized all samples, particularly with ethylene glycol and glycerol for both quill and fiber material and propylene glycol and glycerol for whole feather. This drop in E′ of ethylene glycol and glycerol plasticized quill and fiber materials and propylene glycol and glycerol plasticized feather at T_{g} is similar to the synthetic polymers (usually more than 3 orders of magnitude) (Kalichevsky et al,, 1993). Such α-relaxation followed by a flow region, as can be seen in case of ethylene glycol, is a characteristic behaviour exhibited by thermoplastic materials (Grevellec et al., 2001).

The observation of a single, relatively narrow transition and the strong plasticization effect of ethylene glycol reflect a good compatibility of this plasticizer with feather keratin. This strong plasticization effect can be attributed to the fact that it has the low molecular weight as compared to all other plasticizers investigated, thus having a higher ability to lubricate by incorporating itself among the polymer chains, forming polymer-plasticizer interactions at the expense of polymer-polymer interactions. Its plasticization efficiency is also reflected by significant depression in glass transition, in agreement with the free volume theory of the plasticization (Sears et al., 1982). A sharp decrease in the rubbery modulus is observed in case of ethylene glycol and glycerol. Above the glass transition, E′ depends highly on the density of the polymer crosslinks (Barton, 1979; Gupta et al., 1985). It is expected that the higher the density of polymer-polymer crosslinks, the lower the decrease in rubbery modulus. The decrease in the rubbery modulus is actually due to replacement of polymer-polymer crosslinks by polymer plasticizer interactions (Gontard et al., 1996). The greater the capability of plasticizer to penetrate into polymer chains and make polymer-plasticizer interactions, the lower the possibility of cysteine bonds to be reformed, resulting in a sharp decrease in rubbery modulus and relatively narrow tan delta transitions as was observed in case of ethylene glycol and glycerol plasticized resins. On the contrary, less the ability of plasticizer to diffuse in and interact with polymer chains, more is the chance of cysteine bonds to be reformed and less the decrease in rubbery modulus and broader the tan delta transitions. Very broad transitions (both α and tan delta) and less decrease in the modulus of the rubbery plateau for propylene glycol and diethyl tartrate suggest less efficiency of these plasticizers to diffuse and break up protein-protein network. Propylene glycol was able to plasticize whole feather more effectively, probably due to amphiphilic nature of this plasticizer. Two transitions in both the α-relaxation and tan delta values of glycerol plasticized materials have been observed. These may be assigned to glycerol-rich and protein-rich domains. Glycerol promotes the formation of disordered structures at the expense of β-sheets.

### EXAMPLE 8

### Thermogravimetric Analysis (TGA) Characterizations

TGA was performed on a thermogravimetric analyzer (Pyris 1, Perkin Elmer, Waltham, Mass., USA). About 10 mg of the sample was heated at 10° C./min over a temperature range of 25-600° C. under a nitrogen atmosphere.

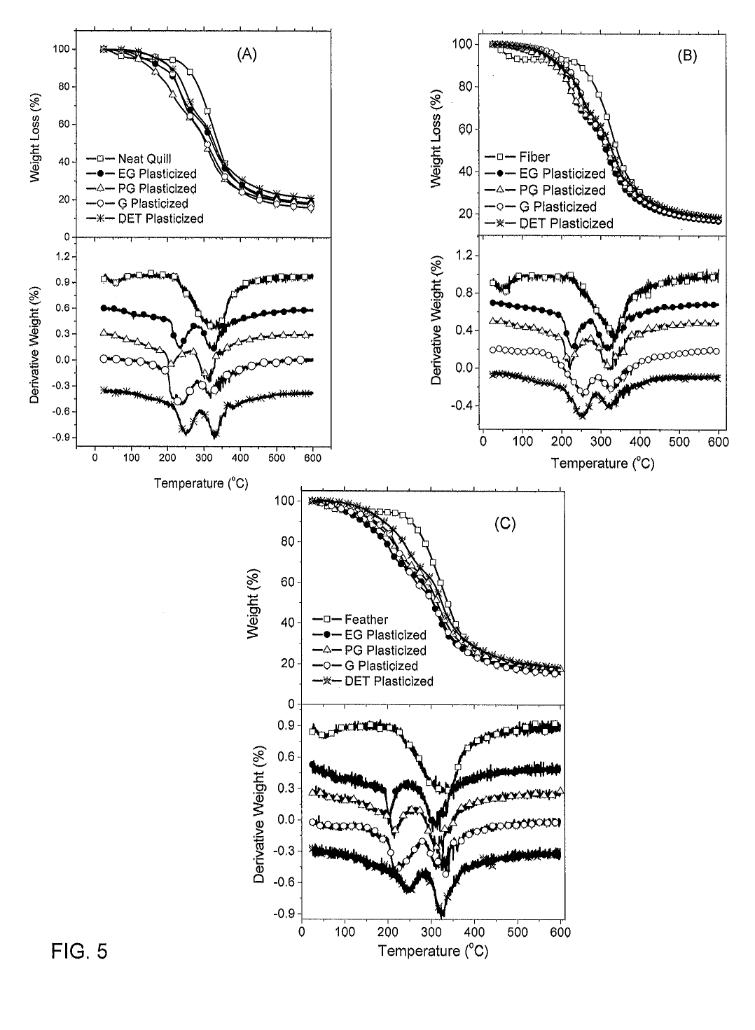

The TG and DTG curves of quill, fiber, and whole feather keratin, and their plasticized materials are shown in FIGS. 5A-C. Two weight loss steps can be seen in case of keratin materials. The weight loss in the first stage (near 100° C.) was due to the evaporation of residual water, whereas the second step (between 250 and 600° C.) was mainly due to the degradation of the keratin. The degradation of each plasticized resin consisted of three weight loss steps. The first gradual weight loss (below 150° C.) is due to the evaporation of moisture, the second (between 150 to 250° C.) is attributed to the plasticizer evaporation, and the final weight loss beyond 250° C. is due to decomposition of keratin material.

Plasticizers act by reducing hydrogen bonding, van der Waals, or ionic interactions that hold polymer chains together, by forming plasticizer-polymer interactions (Leblanc et al., 2008), by adding free volume to the system, and/or by causing a physical separation of adjacent chains, and by acting as lubricants between chains. The temperature at the minimum of DTG curves (Tₘₐₓ) corresponds to the maximum weight loss at that particular temperature. The TQ and DTG curves show that the delay in the onset of loss temperature in the plasticizers loss zone (Tₘₐₓ between 150 to 250° C.) is greater in case of ethylene glycol plasticized resin compared to both propylene glycol and glycerol plasticized resins, due to stronger interactions between ethylene glycol and the polypeptide chains of quill keratin. Two weight loss steps in the plasticizer loss zone can clearly be seen in glycerol plasticized resin, potentially due to glycerol which is loosely bound with protein (glycerol-rich zone) and glycerol which is more strongly bonded with protein. On the other hand, the relatively greater stability of diethyl tartrate plasticized resins compared to propylene glycol and glycerol plasticized materials may result from the comparatively high molecular mass and boiling point (280° C.) of the diethyl tartrate. Diethyl tartrate also has the lowest ability to plasticize and break protein-protein interactions. Similar degradation patterns were observed in fiber-based plasticized resins (FIG. 5B). On the contrary, thermal stability of feather-based resins was little higher in the presence of propylene glycol and glycerol as plasticizers compared to ethylene glycol (FIG. 5C).

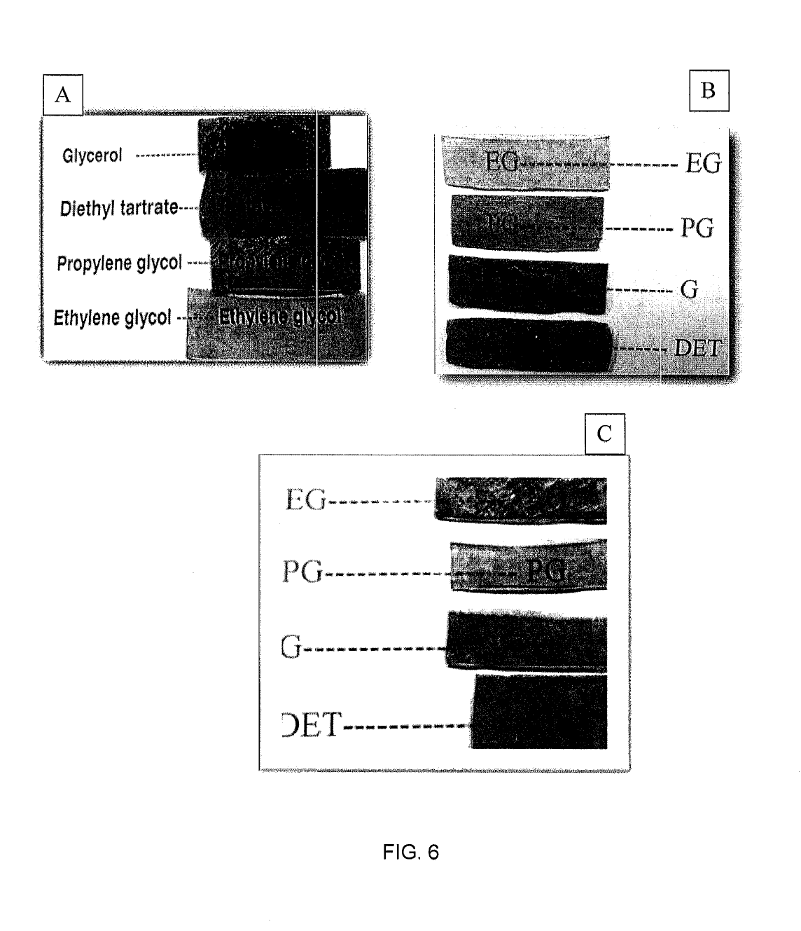

FIG. 6 shows the films prepared from extrudates of quill (A), fiber (B), and feather (C), plasticized with different plasticizers. The EG plasticized film was the most transparent among all in quill-based resins, and propylene glycol and diethyl tartrate showed intermediate clarity. The relatively darker appearance of glycerol plasticized quill-based film may be due to the degradation of keratin in protein-rich zones during thermal processing. Similar trend in transparency was observed in fiber-based resins for ethylene glycol and propylene glycol plasticized resins, while glycerol plasticized resin was relatively less dark in colour compared to quill-based resin developed using glycerol as plasticizer. FIG. 6C, in agreement with structural and thermal characterization, shows that propylene glycol and glycerol are better plasticizers for whole feather keratin.

### REFERENCES

The following references are incorporated herein by reference (where permitted) as if reproduced in their entirety. All references are indicative of the level of skill of those skilled in the art to which this invention pertains.

### Almutawah, A.; Barker, S. A. and Belton, P. S. Biomacromolecules 2007, 8, 1601-1606.

### Anderson, A. K. and Ng, P. K. W. Cereal Chem. 2000, 77, 354-359.

Arai, K. M.; Takahashi, R.; Yokote, Y. and Akahane, K. Eur. J. Biochem. 1983, 132, 501-507.
Barone, J. R.; Schmidt, W. F. and Gregoire, N. T. J Appl. Polym. Sci. 2006, 100, 1432-1442.
Barone, J. R. and Schmidt, W. F. U.S. Pat. No. 7,066,995, issued Jun. 27, 2006.

### Barton, J. M. Polymer 1979, 20, 1018-1024.

Bellamy, L. J. The infrared spectra of complex molecules. Chapman and Hall: London, 1975; p. 108.

### Bengoechea, C.; Arrachid, A.; Guerrero, A.; Hill, S. E. and Mitchell, J. R. J. Cereal Sci. 2007, 45, 275-284.

### Billmeyer, F. W. Textbook of Polymer Science. 2nd ed.; Wiley: New York, 1984; p 246-247.

Brauer, S.; Meister, F.; Gottlober, R. P. and Nechwatal, A. Macromol. Mater. Eng. 2007, 292, 176-183.
Chen, P. and Zhang, L. Macromol. Biosci. 2005, 5, 237-245.
Chen, P.; Zhang, L. and Cao, F. Macromol. Biosci. 2005, 5, 872-880.
Di Gioia, L. and Guilbert, S. P. J. Agric. Food Chem. 1999, 47, 1254-1261.
Fraser, R. D. B.; MacRae, T. P. and Rogers, G. E., Keratins: their composition, structure, and biosynthesis. Kugelmass I. N. ed.; Charles C. Thomas: Springfield, Ill., 1972; p 31.

### Gilbert, V.; Rouabhia, M.; Wang, H.; Arnould, A.-L.; Remondetto, G. and Subirade, M. Biomaterials 2005, 26, 7471-7480.

Gontard, N. and Ring, S. J. Agric. Food Chem. 1996, 44, 3474-3478.

### Grevellec, J.; Marquie, C.; Ferry, L.; Crespy, A. and Vialettes, V. Biomacromolecules 2001, 2, 1104-1109.

Gupta, V. B.; Drzal, L. T.; Lee, C. Y. C. and Rich, M. J. Polym. Eng. Sci. 1985, 25, 812-823.
Jackson, M. and Mantsch, H. H. Crit. Rev. Biochem. Mol. 1995, 30, 95-120.
Jin, E.; Reddy, N.; Zhu, Z. and Yang, Y. J. Agric. Food Chem. 2011, 59, 1729-1738.
Jung, C. J. Mol. Recognit. 2000, 13, 325-351.
Kalichevsky, M. T.; Blanshard, J. M. V. and Marsh, R. D. L. Application of mechanical spectroscopy to the study of glassy biopolymers and related systems. In The Glassy State in Foods, Blanshard, J. M. V.; Lillford, P. J., Eds. Nottingham University Press: Nottingham, U.K: 1993; p 133-156.
Leblanc, N.; Saiah, R.; Beucher, E.; Gattin, R.; Castandet, M. and Saiter, J. M. Carbohyd. Polym. 2008, 73, 548-557.
Mangavel, C.; Barbot, J.; Gueguen, J. and Popineau, Y. J. Agric. Food Chem, 2003, 51, 1447-1452.
Martinez-Hernandez, A. L.; Velasco-Santos, C.; Icaza, M. D. and Castano, V. M. e-Polym. 2003, 016, 1-11.
Reddy, N. and Yang, Y. J. Polym. Environ. 2007, 15, 81-87.

### Redl, A.; Morel, M. H.; Bonicel, J.; Vergnes, B. and Guilbert, S. Cereal Chem. 1999, 76, 361-370.

### Schmidt, M.; Gierlinger, N.; Schade, U.; Rogge, T. and Grunze, M. Biopolymers 2006, 83, 546-555.

Schmidt, W. F. and Jayasundera, S. Microcrystalline keratin fiber. In Natural fibers plastics, and composites-recent advances, Wallenberger, F. T.; Weston, N. E., Eds. Kluwer Academic Publishers: Norwell, Mass., 2003; p 51.
Schrooyen, P. M. M.; Dijkstra, P. J.; Oberthur, R. C.; Bantjes, A. and Feijen, J. J. Agric. Food Chem. 2000, 49, 221-230.
Schrooyen, P. M. M.; Dijkstra, P. J.; Oberthuer, R. C.; Bantjes, A. and Feijen, J. J. Agric. Food Chem. 2001, 49, 221-230.
Sears, J. K. and Darby, J. R., Eds. Mechanism of plasticizer action. In The Technology of Plasticizers, Wiley-Interscience: New York, 1982; p 35-77.
Sessa, D. J.; Selling, G. W.; Willett, J. L. and Palmquist, D. E. Ind. Crops Product. 2006, 23, 15-22.

### Smith, B. C. Infrared Spectral Interpretation, a Systematic Approach. CRC Press Inc: Boca Raton, Fla., 1999; p 158.

Trabocchi, A.; Occhiato, E. G.; Potenza, D. and Guarna, A. J. Org. Chem. 2002, 67, 7483-7492.
Verbeek, C. J. R. and van den Berg, L. E. Macromol. Mater. Eng. 2010, 295, 10-21.

### Vincent, J. F. V., Structural Biomaterials. Princeton University Press: 1990.

### Vroman, I. and Tighzert, L. Materials 2009, 2, 307-344.

Wei, W. and Baianu, I. C. Macromol. Symp. 1999, 140, 197-209.

1. A method of producing a thermoplastic from feathers, comprising the steps of:
a) blending whole feathers or portions thereof with a plasticizer in an amount ranging from about 20 wt % to about 40 wt %, and a reducing agent in an amount ranging from about 1 wt % to about 5 wt %, to form a resin mixture; and
b) either extruding the mixture to form an article or pressing the mixture into a film, at an elevated temperature.

2. The method of claim 1, wherein the plasticizer comprises a polar or an amphiphilic plasticizer.

3. The method of claim 2, wherein the plasticizer comprises propylene glycol, glycerol, ethylene glycol, or diethyl tartrate.

4. The method of claim 3, wherein the portion comprises quill or feather fiber, and the plasticizer comprises ethylene glycol or diethyl tartrate.

5. The method of claim 3, wherein whole feathers are blended with the plasticizer comprising propylene glycol or glycerol.

6. The method of claim 1, wherein the plasticizer is in an amount of about 30 wt %, and the reducing agent is in an amount of about 3 wt %.

7. The method of claim 1, wherein the reducing agent comprises sodium sulfite, potassium cyanide, or thioglycolic acid.

8. The method of claim 7, wherein the reducing agent comprises sodium sulfite.

9. The method of claim 1, wherein extrusion is conducted at a temperature in the range of about 90° C. to about 140° C.

10. The method of claim 9, wherein a twin-screw extruder is used.

11. The method of claim 1, wherein pressing comprises compression molding.

12. The method of claim 11, wherein compression molding is conducted at a pressure of about 3,500 psi for about five minutes.

13. The method of claim 12, wherein compression molding is conducted at a temperature of about 110° C.

14. A thermoplastic comprising a resin comprising feather keratin, a plasticizer, and a reducing agent.

15. An article comprising a thermoplastic as claimed in claim 14.
